(19) United States
(12) Patent Application Publication
(10) Pub. No.: US 2026/0197489 A1
(43) Pub. Date: Jul. 9, 2026

(54) INTERPOLATION FILTERS FOR TEMPLATE MATCHING AND DECODER-SIDE MOTION VECTOR REFINEMENT

(71) Applicant: Alibaba (China) Co., Ltd., Hangzhou (CN)

(72) Inventors: Zhenyu DAI, Hangzhou (CN); Ru-ling Liao, Sunnyvale, CA (US); Yan Ye, San Diego, CA (US); Xinwei Li, Beijing (CN); Jie Chen, Beijing (CN)

(21) Appl. No.: 19/437,019

(22) Filed: Dec. 30, 2025

Related U.S. Application Data
(60) Provisional application No. 63/742,388, filed on Jan. 6, 2025.

(51) Int. Cl. H04N 19/513; H04N 19/117; H04N 19/159; H04N 19/184; H04N 19/82

(52) U.S. Cl. CPC H04N 19/521; H04N 19/117; H04N 19/159; H04N 19/184; H04N 19/82

(57) ABSTRACT

Methods and systems implement interpolation filters for motion prediction, and more specifically interpolation filters for template matching and decoder-side motion vector refinement (“DMVR”). A VVC and later standard encoder and a VVC and later standard decoder can configure one or more processors of a computing system to signal that at least one of a first filter derived by discrete cosine transform-based interpolation filter, a second filter derived by a cubic-based interpolation filter, and a third filter derived by a cubic-based interpolation filter are applied in a template matching-based mode, applied in DMVR search, or applied in both.

### RELATED APPLICATIONS

This application claims the benefit of U.S. Patent Application No. 63/742,388, entitled “INTERPOLATION FILTERS FOR TEMPLATE MATCHING AND DECODER-SIDE MOTION VECTOR REFINEMENT” and filed Jan. 6, 2025, which are expressly incorporated herein by reference in their entirety.

### BACKGROUND

In 2020, the Joint Video Experts Team (“JVET”) of the ITU-T Video Coding Expert Group (“ITU-T VCEG”) and the ISO/IEC Moving Picture Expert Group (“ISO/IEC MPEG”) published the final draft of the next-generation video codec specification, Versatile Video Coding (“VVC”). This specification further improves video coding performance over prior standards such as H.264/AVC (Advanced Video Coding) and H.265/HEVC (High Efficiency Video Coding). The JVET developed further techniques beyond the scope of the VVC standard under the Enhanced Compression Model (“ECM”) name, which has formed the basis for the successor H.267 standard currently in draft status.

According to VVC and later standards, Decoder-side Motion Vector Refinement (“DMVR”), including multi-pass DMVR and adaptive DMVR, is a coding tool to refine the MV at decoder-side without additional signaling, as the MV inheriting from the neighboring block may not perfectly match with the current block. Affine motion compensation may be used to capture the affine motion between two different frames. According to DMVR, bi-prediction may be performed upon a current CU such that motion information of the current CU includes weighted averaging of two prediction signals, the weight index being inferred from neighboring blocks based on a merge candidate index.

According to VVC and later standards, Template matching (“TM”) is a decoder-side MV derivation method to refine the motion information of the current CU by finding the closest match between a template (i.e., top and/or left neighboring blocks of the current CU) in the current picture and a block (i.e., same size to the template) in a reference picture.

Moreover, at time of writing, the latest draft of ECM (presented at the 40th meeting of the JVET in October 2025 as “Algorithm description of Enhanced Compression Model 19 (ECM 19)”) implements interpolation filters in template matching and DMVR.

There is a need to further improve coding performance of template matching and DMVR.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIGS. 1A and 1B illustrate example block diagrams of, respectively, an encoding process and a decoding process according to an example embodiment of the present disclosure.

FIG. 2 illustrates a diagram of bilateral matching costs used in a second pass of a multi-pass decoder-side motion vector refinement.

FIG. 3 illustrates finding the closest match between a template in the current picture and a block in a reference picture.

FIG. 4 illustrates a flowchart of a template-based refinement process.

FIGS. 5A and 5B illustrate deriving reference samples of each sub-template from motion information of the subblocks in the first row and the first column of a current block.

FIG. 6 illustrates templates applied according to overlapped block motion compensation (“OBMC”).

FIG. 7 illustrates additional refinement positions along k×π/8 diagonal angles.

FIG. 8 illustrates classifications of geometric partitions by their respective angles.

FIG. 9 illustrates an example of extending a partition splitting line of a current CU.

FIG. 10 illustrates TM refinement for both intra block copy with template matching (“IBC-TM”) merge and adaptive motion vector prediction (“AMVP”) modes.

FIG. 11 illustrates frequency responses of higher tap-length interpolation filters compared to frequency responses of the VVC and later interpolation filter, all at half-pel phase.

FIG. 12 illustrates magnitude responses of three higher tap-length interpolation filters (e.g., 4/16 phase) according to example embodiments of the present disclosure.

FIG. 13 illustrates an example system for implementing the processes and methods described herein for implementing interpolation filters for template matching and DMVR.

### DETAILED DESCRIPTION

Systems and methods discussed herein are directed to implementing interpolation filters for motion prediction, and more specifically interpolation filters for template matching and decoder-side motion vector refinement (“DMVR”).

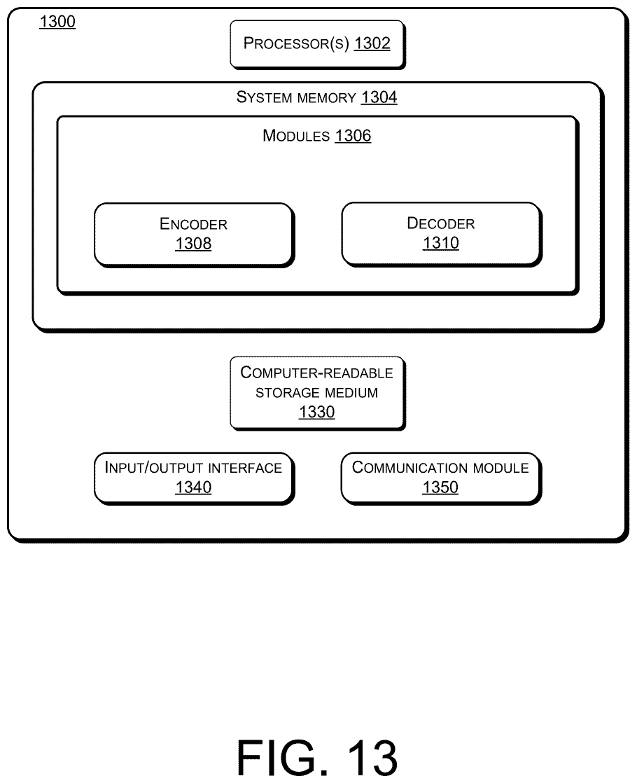

In accordance with the VVC video coding standard and successor standards currently in draft status such as H.267 (“VVC and later standards”) and motion prediction as described therein, a computing system includes at least one or more processors and a computer-readable storage medium communicatively coupled to the one or more processors. The computer-readable storage medium is a non-transient or non-transitory computer-readable storage medium, as defined subsequently with reference to FIG. 13, storing computer-readable instructions. At least some computer-readable instructions stored on a computer-readable storage medium are executable by one or more processors of a computing system to configure the one or more processors to perform associated operations of the computer-readable instructions, including at least operations of an encoder as described by VVC and later standards, and operations of a decoder as described by VVC and later standards. Some of these encoder operations and decoder operations according to VVC and later standards are subsequently described in further detail, though these subsequent descriptions should not be understood as exhaustive of encoder operations and decoder operations according to VVC and later standards. Subsequently, a “VVC and later standard encoder” and a “VVC and later standard decoder” shall describe the respective computer-readable instructions stored on a computer-readable storage medium which configure one or more processors to perform these respective operations (which can be called, by way of example, “reference implementations” of an encoder or a decoder).

Moreover, according to example embodiments of the present disclosure, a VVC and later standard encoder and a VVC and later standard decoder further include computer-readable instructions stored on a computer-readable storage medium which are executable by one or more processors of a computing system to configure the one or more processors to perform operations not specified by VVC and later standards. A VVC and later standard encoder should not be understood as limited to operations of a reference implementation of an encoder, but including further computer-readable instructions configuring one or more processors of a computing system to perform further operations as described herein. A VVC and later standard decoder should not be understood as limited to operations of a reference implementation of a decoder, but including further computer-readable instructions configuring one or more processors of a computing system to perform further operations as described herein.

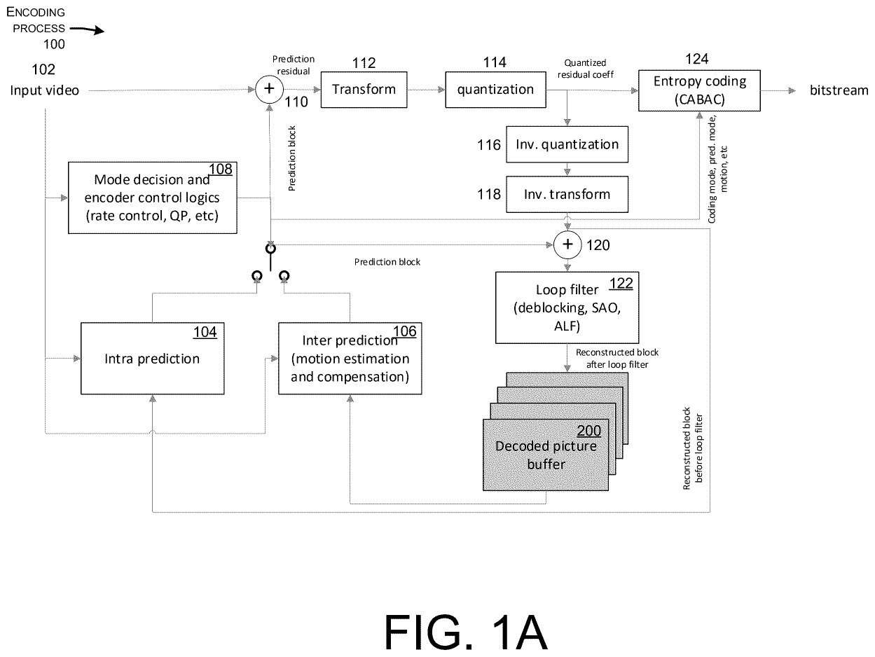

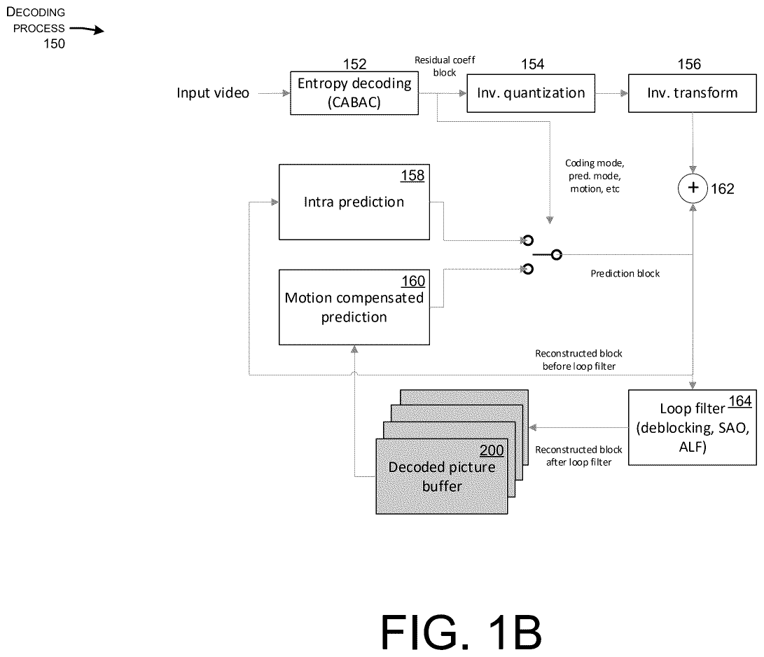

FIGS. 1A and 1B illustrate example block diagrams of, respectively, an encoding process 100 and a decoding process 150 according to an example embodiment of the present disclosure.

In an encoding process 100, a VVC and later standard encoder configures one or more processors of a computing system to receive, as input, one or more input pictures from an image source 102. An input picture includes some number of pixels sampled by an image capture device, such as a photosensor array, and includes an uncompressed stream of multiple color channels (such as RGB color channels) storing color data at an original resolution of the picture, where each channel stores color data of each pixel of a picture using some number of bits. A VVC and later standard encoder configures one or more processors of a computing system to store this uncompressed color data in a compressed format, wherein color data is stored at a lower resolution than the original resolution of the picture, encoded as a luma (“Y”) channel and two chroma (“U” and “V”) channels of lower resolution than the luma channel.

A VVC and later standard encoder encodes a picture (a picture being encoded being called a “current picture,” as distinguished from any other picture received from an image source 102) by configuring one or more processors of a computing system to partition the original picture into units and subunits according to a partitioning structure. A VVC and later standard encoder configures one or more processors of a computing system to subdivide a picture into macroblocks (“MBs”) each having dimensions of 16×16 pixels, which may be further subdivided into partitions. A VVC and later standard encoder configures one or more processors of a computing system to subdivide a picture into coding tree units (“CTUs”), the luma and chroma components of which may be further subdivided into coding tree blocks (“CTBs”) which are further subdivided into coding units (“CUs”). Alternatively, a VVC and later standard encoder configures one or more processors of a computing system subdivide a picture into units of N×N pixels, which may then be further subdivided into subunits. Each of these largest subdivided units of a picture may generally be referred to as a “block” for the purpose of this disclosure.

A CU is coded using one block of luma samples and two corresponding blocks of chroma samples, where pictures are not monochrome and are coded using one coding tree.

A VVC and later standard encoder configures one or more processors of a computing system to subdivide a block into partitions having dimensions in multiples of 4×4 pixels. For example, a partition of a block may have dimensions of 8×4 pixels, 4×8 pixels, 8×8 pixels, 16×8 pixels, or 8×16 pixels.

By encoding color information of blocks of a picture and subdivisions thereof, rather than color information of pixels of a full-resolution original picture, a VVC and later standard encoder configures one or more processors of a computing system to encode color information of a picture at a lower resolution than the input picture, storing the color information in fewer bits than the input picture.

Furthermore, a VVC and later standard encoder encodes a picture by configuring one or more processors of a computing system to perform motion prediction upon blocks of a current picture. Motion prediction coding refers to storing image data of a block of a current picture (where the block of the original picture, before coding, is referred to as an “input block”) using motion information and prediction units (“PUs”), rather than pixel data, according to intra prediction 104 or inter prediction 106.

Motion information refers to data describing motion of a block structure of a picture or a unit or subunit thereof, such as motion vectors and references to blocks of a current picture or of a reference picture. PUs may refer to a unit or multiple subunits corresponding to a block structure among multiple block structures of a picture, such as an MB or a CTU, wherein blocks are partitioned based on the picture data and are coded according to VVC and later standards. Motion information corresponding to a PU may describe motion prediction as encoded by a VVC and later standard encoder as described herein.

A VVC and later standard encoder configures one or more processors of a computing system to code motion prediction information over each block of a picture in a coding order among blocks, such as a raster scanning order wherein a first-decoded block is an uppermost and leftmost block of the picture. A block being encoded is called a “current block,” as distinguished from any other block of a same picture.

According to intra prediction 104, one or more processors of a computing system are configured to encode a block by references to motion information and PUs of one or more other blocks of the same picture. According to intra prediction coding, one or more processors of a computing system perform an intra prediction 104 (also called spatial prediction) computation by coding motion information of the current block based on spatially neighboring samples from spatially neighboring blocks of the current block.

According to inter prediction 106, one or more processors of a computing system are configured to encode a block by references to motion information and PUs of one or more other pictures. One or more processors of a computing system are configured to store one or more previously coded and decoded pictures in a reference picture buffer for the purpose of inter prediction coding; these stored pictures are called reference pictures.

One or more processors are configured to perform an inter prediction 106 (also called temporal prediction or motion compensated prediction) computation by coding motion information of the current block based on samples from one or more reference pictures. Inter prediction may further be computed according to uni-prediction or bi-prediction: in uni-prediction, only one motion vector, pointing to one reference picture, is used to generate a prediction signal for the current block. In bi-prediction, two motion vectors, each pointing to a respective reference picture, are used to generate a prediction signal of the current block.

A VVC and later standard encoder configures one or more processors of a computing system to code a CU to include reference indices to identify, for reference of a VVC and later standard decoder, the prediction signal(s) of the current block. One or more processors of a computing system can code a CU to include an inter prediction indicator. An inter prediction indicator indicates list 0 prediction in reference to a first reference picture list referred to as list 0, list 1 prediction in reference to a second reference picture list referred to as list 1, or bi-prediction in reference to both reference picture lists referred to as, respectively, list 0 and list 1.

In the cases of the inter prediction indicator indicating list 0 prediction or list 1 prediction, one or more processors of a computing system are configured to code a CU including a reference index referring to a reference picture of the reference picture buffer referenced by list 0 or by list 1, respectively. In the case of the inter prediction indicator indicating bi-prediction, one or more processors of a computing system are configured to code a CU including a first reference index referring to a first reference picture of the reference picture buffer referenced by list 0, and a second reference index referring to a second reference picture of the reference picture referenced by list 1.

A VVC and later standard encoder configures one or more processors of a computing system to code each current block of a picture individually, outputting a prediction block for each. According to VVC and later standards, a CTU can be as large as 128×128 luma samples (plus the corresponding chroma samples, depending on the chroma format). A CTU may be further partitioned into CUs according to a quad-tree, binary tree, or ternary tree. One or more processors of a computing system are configured to ultimately record coding parameter sets such as coding mode (intra mode or inter mode), motion information (reference index, motion vectors, etc.) for inter-coded blocks, and quantized residual coefficients, at syntax structures of leaf nodes of the partitioning structure.

After a prediction block is output, a VVC and later standard encoder configures one or more processors of a computing system to send coding parameter sets such as coding mode (i.e., intra or inter prediction), a mode of intra prediction or a mode of inter prediction, and motion information to an entropy coder 124 (as described subsequently).

VVC and later standards provide semantics for recording coding parameter sets for a CU. For example, with regard to the above-mentioned coding parameter sets, pred_mode_flag for a CU is set to 0 for an inter-coded block, and is set to 1 for an intra-coded block; general_merge_flag for a CU is set to indicate whether merge mode is used in inter prediction of the CU; inter_affine_flag and cu_affine_type_flag for a CU are set to indicate whether affine motion compensation is used in inter prediction of the CU; mvp_l0_flag and mvp_l1_flag are set to indicate a motion vector index in list 0 or in list 1, respectively; and ref_idx_l0 and ref_idx_l1 are set to indicate a reference picture index in list 0 or in list 1, respectively. It should be understood that VVC and later standards include semantics for recording various other information, flags, and options which are beyond the scope of the present disclosure.

A VVC and later standard encoder further implements one or more mode decision and encoder control settings 108, including rate control settings. One or more processors of a computing system are configured to perform mode decision by, after intra or inter prediction, selecting an optimized prediction mode for the current block, based on the rate-distortion optimization (“RDO”) method.

A rate control setting configures one or more processors of a computing system to assign different quantization parameters (“QPs”) to different pictures. Magnitude of a QP determines a scale over which picture information is quantized during encoding by one or more processors (as shall be subsequently described), and thus determines an extent to which the encoding process 100 discards picture information (due to information falling between steps of the scale) from MBs of the sequence during coding.

A VVC and later standard encoder further implements a subtractor 110. One or more processors of a computing system are configured to perform a subtraction operation by computing a difference between an input block and a prediction block. Based on the optimized prediction mode, the prediction block is subtracted from the input block. The difference between the input block and the prediction block is called prediction residual, or “residual” for brevity.

Based on a prediction residual, a VVC and later standard encoder further implements a transform 112. One or more processors of a computing system are configured to perform a transform operation on the residual by a matrix arithmetic operation to compute an array of coefficients (which can be referred to as “residual coefficients,” “transform coefficients,” and the like), thereby encoding a current block as a transform block (“TB”). Transform coefficients may refer to coefficients representing one of several spatial transformations, such as a diagonal flip, a vertical flip, or a rotation, which may be applied to a sub-block.

It should be understood that a coefficient can be stored as two components, an absolute value and a sign, as shall be described in further detail subsequently.

Sub-blocks of CUs, such as PUs and TBs, can be arranged in any combination of sub-block dimensions as described above. A VVC and later standard encoder configures one or more processors of a computing system to subdivide a CU into a residual quadtree (“RQT”), a hierarchical structure of TBs. The RQT provides an order for motion prediction and residual coding over sub-blocks of each level and recursively down each level of the RQT.

A VVC and later standard encoder further implements a quantization 114. One or more processors of a computing system are configured to perform a quantization operation on the residual coefficients by a matrix arithmetic operation, based on a quantization matrix and the QP as assigned above. Residual coefficients falling within an interval are kept, and residual coefficients falling outside the interval step are discarded.

A VVC and later standard encoder further implements an inverse quantization 116 and an inverse transform 118. One or more processors of a computing system are configured to perform an inverse quantization operation and an inverse transform operation on the quantized residual coefficients, by matrix arithmetic operations which are the inverse of the quantization operation and transform operation as described above. The inverse quantization operation and the inverse transform operation yield a reconstructed residual.

A VVC and later standard encoder further implements an adder 120. One or more processors of a computing system are configured to perform an addition operation by adding a prediction block and a reconstructed residual, outputting a reconstructed block.

A VVC and later standard encoder further implements a loop filter 122. One or more processors of a computing system are configured to apply a loop filter, such as a deblocking filter, a sample adaptive offset (“SAO”) filter, and adaptive loop filter (“ALF”) to a reconstructed block, outputting a filtered reconstructed block.

A VVC and later standard encoder further configures one or more processors of a computing system to output a filtered reconstructed block to a decoded picture buffer (“DPB”) 200. A DPB 200 stores reconstructed pictures which are used by one or more processors of a computing system as reference pictures in coding pictures other than the current picture, as described above with reference to inter prediction.

A VVC and later standard encoder further implements an entropy coder 124. One or more processors of a computing system are configured to perform entropy coding, wherein, according to the Context-Sensitive Binary Arithmetic Codec (“CABAC”), symbols making up quantized residual coefficients are coded by mappings to binary strings (subsequently “bins”), which can be transmitted in an output bitstream at a compressed bitrate. The symbols of the quantized residual coefficients which are coded include absolute values of the residual coefficients (these absolute values being subsequently referred to as “residual coefficient levels”).

Thus, the entropy coder configures one or more processors of a computing system to code residual coefficient levels of a block; bypass coding of residual coefficient signs and record the residual coefficient signs with the coded block; record coding parameter sets such as coding mode, a mode of intra prediction or a mode of inter prediction, and motion information coded in syntax structures of a coded block (such as a picture parameter set (“PPS”) found in a picture header, as well as a sequence parameter set (“SPS”) found in a sequence of multiple pictures); and output the coded block.

A VVC and later standard encoder configures one or more processors of a computing system to output a coded picture, made up of coded blocks from the entropy coder 124. The coded picture is output to a transmission buffer, where it is ultimately packed into a bitstream for output from the VVC and later standard encoder. The bitstream is written by one or more processors of a computing system to a non-transient or non-transitory computer-readable storage medium of the computing system, for transmission.

In a decoding process 150, a VVC and later standard decoder configures one or more processors of a computing system to receive, as input, one or more coded pictures from a bitstream.

A VVC and later standard decoder implements an entropy decoder 152. One or more processors of a computing system are configured to perform entropy decoding, wherein, according to CABAC, bins are decoded by reversing the mappings of symbols to bins, thereby recovering the entropy-coded quantized residual coefficients. The entropy decoder 152 outputs the quantized residual coefficients, outputs the coding-bypassed residual coefficient signs, and also outputs the syntax structures such as a PPS and a SPS.

A VVC and later standard decoder further implements an inverse quantization 154 and an inverse transform 156. One or more processors of a computing system are configured to perform an inverse quantization operation and an inverse transform operation on the decoded quantized residual coefficients, by matrix arithmetic operations which are the inverse of the quantization operation and transform operation as described above. The inverse quantization operation and the inverse transform operation yield a reconstructed residual.

Furthermore, based on coding parameter sets recorded in syntax structures such as PPS and a SPS by the entropy coder 124 (or, alternatively, received by out-of-band transmission or coded into the decoder), and a coding mode included in the coding parameter sets, the VVC and later standard decoder determines whether to apply intra prediction 158 (i.e., spatial prediction) or to apply motion compensated prediction 160 (i.e., temporal prediction) to the reconstructed residual.

In the event that the coding parameter sets specify intra prediction, the VVC and later standard decoder configures one or more processors of a computing system to perform intra prediction 158 using prediction information specified in the coding parameter sets. The intra prediction 158 thereby generates a prediction signal.

In the event that the coding parameter sets specify inter prediction, the VVC and later standard decoder configures one or more processors of a computing system to perform motion compensated prediction 160 using a reference picture from a DPB 200. The motion compensated prediction 160 thereby generates a prediction signal.

A VVC and later standard decoder further implements an adder 162. The adder 162 configures one or more processors of a computing system to perform an addition operation on the reconstructed residuals and the prediction signal, thereby outputting a reconstructed block.

A VVC and later standard decoder further implements a loop filter 164. One or more processors of a computing system are configured to apply a loop filter, such as a deblocking filter, a SAO filter, and ALF to a reconstructed block, outputting a filtered reconstructed block.

A VVC and later standard decoder further configures one or more processors of a computing system to output a filtered reconstructed block to the DPB 200. As described above, a DPB 200 stores reconstructed pictures which are used by one or more processors of a computing system as reference pictures in coding pictures other than the current picture, as described above with reference to motion compensated prediction.

A VVC and later standard decoder further configures one or more processors of a computing system to output reconstructed pictures from the DPB to a user-viewable display of a computing system, such as a television display, a personal computing monitor, a smartphone display, or a tablet display.

Therefore, as illustrated by an encoding process 100 and a decoding process 150 as described above, a VVC and later standard encoder and a VVC and later standard decoder each implements motion prediction coding in accordance with VVC and later standard specifications. A VVC and later standard encoder and a VVC and later standard decoder each configures one or more processors of a computing system to generate a reconstructed picture based on a previous reconstructed picture of a DPB according to motion compensated prediction as described by VVC and later standards, wherein the previous reconstructed picture serves as a reference picture in motion compensated prediction as described herein.

According to ECM, to further improve coding efficiency, a multi-pass decoder-side motion vector (“DMVR”) refinement is applied. In the first pass, block matching (“BM”) is applied to the coding block. In the second pass, BM is applied to each 16×16 subblock within the coding block. In the third pass, the MV in each 8×8 subblock is refined by applying bi-directional optical flow (“BDOF”). The refined MVs are stored for both spatial and temporal motion vector prediction.

In the first pass, a refined MV is derived by applying BM to a coding block. Similar to DMVR, in bi-prediction, a refined MV is searched near the two initial MVs (MV0 and MV1) in the reference picture lists L0 and L1. The refined MVs (MV0_pass1 and MV1_pass1) are derived near the initial MVs based on the minimum bilateral matching cost between the two reference blocks in L0 and L1.

BM-based refinement performs a local search to derive integer sample precision intDeltaMV. The local search applies a 3×3 square search pattern to loop through the search range [−sHor, sHor] in a horizontal direction and [−sVer, sVer] in a vertical direction, wherein, the values of sHor and sVer are determined by the block dimension, and the maximum value of sHor and sVer is 8, or has other values.

The bilateral matching cost can be calculated according to Equation 1 below:

$$bilCost = mvDistanceCost + sadCost$$

wherein sadCost is the sum of absolute differences (“SAD”) between L0 predictor (i.e., a reference block from reference picture L0) and L1 predictor (i.e., a reference block from reference picture L1) on a search point and mvDistanceCost is based on intDeltaMV (i.e., the distance between the search point and the initial point). When the block size cbW (CB width, in pixels)×cbH (CB height, in pixels) is greater than 64, the mean-removed SAD (“MRSAD”) cost function is applied to remove the discrete cosine (“DC”) effect of distortion between reference blocks. When the bilCost at the center point of the 3×3 search pattern has the minimum cost, the intDeltaMV local search terminates. Otherwise, the current minimum cost search point is set as the new center point of the 3×3 search pattern and the search for the minimum cost continues, until the end of the search range is reached.

The existing fractional sample refinement is further applied to derive fractional MV refinement fracDeltaMV, and the final deltaMV is derived as intDeltaMV+fracDeltaMV. The refined MVs after the first pass are then respectively derived according to Equation 2 and Equation 3 below:

$$\begin{matrix}MV0\_pass1 = M {V}_{0} + deltaMV \\ MV1\_pass1 = M {V}_{1} - deltaMV\end{matrix}$$

In the second pass, a refined MV is derived by applying BM to a 16×16 grid subblock. For each subblock, a refined MV is searched near the two MVs (MV0pass1 and MV1pass1), obtained on the first pass, in the reference picture list L0 and L1. The refined MVs (MV0_pass2(sbIdx2) and MV1_pass2(sbIdx2)) are derived based on the minimum bilateral matching cost between the two reference subblocks in L0 and L1.

For each subblock, BM-based refinement performs a full search to derive integer sample precision intDeltaMV(sbIdx2). The full search has a search range [−sHor, sHor] in a horizontal direction and [−sVer, sVer] in a vertical direction, wherein the values of sHor and sVer are determined by the block dimension, and the maximum value of sHor and sVer is 8 or other values.

The bilateral matching cost can be calculated by applying a cost factor to the sum of absolute transformed differences (“SATD”) cost between two reference subblocks, according to Equation 4 below:

$$bilCost = satdCost \times costFactor$$

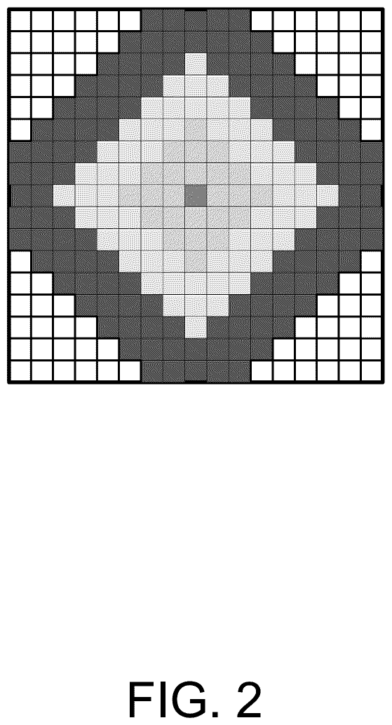

The search area (2×sHor+1)×(2×sVer+1) is divided up to 5 diamond-shaped search regions, as shown in FIG. 2. FIG. 2 illustrates a diagram of bilateral matching costs (each matching cost corresponding to a differently-shaded diamond-shaped search region) used in a second pass of a multi-pass decoder-side motion vector refinement. Each search region is assigned a costFactor, which is determined by the distance intDeltaMV(sbIdx2) between each search point and the starting MV, and each diamond-shaped region is processed in order starting from the center of the search area. In each region, the search points are processed in the raster scan order starting from the top left going to the bottom right corner of the region. When the minimum bilCost within the current search region is less than a threshold equal to sbW (subblock width)×sbH (subblock height), the int-pel full search terminates; otherwise, the int-pel full search continues to the next search region until all search points are examined. Additionally, if the difference between the previous minimum cost and the current minimum cost in the iteration is less than a threshold that is equal to the area of the block, the search terminates.

Furthermore, the bilateral matching costs as described above can also be calculated based on MRSAD instead of SAD, and can also be calculated based on mean-removed sum of absolute transformed differences (“MRSATD”) instead of SATD.

VVC and later standard DMVR fractional sample refinement is further applied to derive the final deltaMV(sbIdx2). The refined MVs at second pass are then respectively derived according to Equation 5 and Equation 6 below:

$$\begin{matrix}MV0\_pass2 ( sb I d x 2 ) = MV0\_pass1 + deltaMV ( s b I d x 2 ) \\ MV1\_pass2 ( s b I d x 2 ) = MV1\_pass1 - deltaMV ( sb I d x 2 )\end{matrix}$$

In the third pass, a refined MV is derived by applying BDOF to an 8×8 grid subblock. For each 8×8 subblock, BDOF refinement is applied to derive scaled Vₓ and V_{y} without clipping starting from the refined MV of the parent subblock of the second pass. The derived bioMv(Vₓ, V_{y}) is rounded to 1/16 sample precision and clipped between −32 and 32.

The refined MVs (MV0_pass3(sbIdx3) and MV1_pass3(sbIdx3)) at third pass are respectively derived according to Equation 7 and Equation 8 below:

$$\begin{matrix}MV0\_pass3 ( sbIdx 3 ) = MV0\_pass2 ( sbIdx 2 ) + bioMv \\ MV1\_pass3 ( sbIdx 3 ) = MV0\_pass2 ( sbIdx 2 ) - bioMv\end{matrix}$$

In the fourth pass, a refined MV is derived by applying BDOF to an 4×4 or 8×8 or 16×16 grid subblock. When a block is smaller than 1024 pixels, the 4×4 grid subblock is used. Otherwise, 8×8 grid subblock is used. The MV of each subblock is refined in the same way as that used in third pass.

With reference to DMVR as described above, when wrap around motion compensation is enabled, the motion vectors shall be clipped with wrap around offset taken into consideration. According to ECM, DMVR is extended to non-equal picture order count (“POC”) distance cases, and mean removed equations are utilized to derive the BDOF MV refinement parameters (a.k.a., high accuracy sample adjustment method) by Equation 9 and Equation 10 below:

$$( \sum Gx \cdot Gx + R 1 ) * vx + \sum Gx \cdot Gy * vy = \sum dI \cdot Gx \cdot \to ( \sum Gx \cdot Gx + R 1 ) * vx + \sum Gx \cdot Gy * vy = \sum dI \cdot Gx - dM \cdot \sum Gx$$

$$\sum Gx \cdot Gy * vx + ( \sum Gy \cdot Gy + R 1 ) * vy = \sum dI \cdot Gy \to \sum Gx \cdot Gy * vx + ( \sum Gy \cdot Gy + R 1 ) * vy = \sum dI \cdot Gy - dM \cdot \sum Gy$$

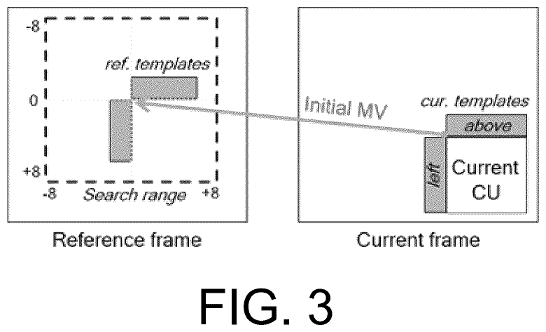

Template matching (“TM”) is a decoder-side MV derivation method to refine the motion information of the current coding block by finding the closest match between a template (i.e., top and/or left neighboring blocks of the current coding block) in the current picture and a block (i.e., same size to the template) in a reference picture. As illustrated in FIG. 3, a better MV is searched around the initial motion of the current coding block within a [−8, +8]-pel search range. TM mode can be applied to merge mode and Advanced Motion Vector Prediction (“AMVP”) mode.

In merge mode, a merge candidate indicated by the signaled merge index is used as initial motion. As Table 1 shows, TM can be performed to the precision of ⅛-pel MVD precision, or can skip those precisions beyond half-pel MVD precision, depending on whether the alternative interpolation filter (that is used when AMVR is of half-pel mode) is used according to merged motion information.

Beside merge mode, TM can also be applied in non-merge inter mode, usually called AMVP mode. In AMVP mode, an MVP candidate is determined based on template matching error to select the one which reaches the minimum cost. The cost is calculated as the difference between the current block template and the reference block template. TM is performed only for this particular MVP candidate for MV refinement. Performing TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 1 below.

| | AMVR mode | | | | Merge mode | |
|---|---|---|---|---|---|---|
| | 4- | Full- | Half- | Quarter- | AltIF = | AltIF = |
| Search pattern | pel | pel | pel | pel | 0 | 1 |
| 4-pel diamond | x | | | | | |
| 4-pel cross | x | | | | | |
| Full-pel diamond | | x | x | x | x | x |
| Full-pel cross | | x | x | x | x | x |
| Half-pel cross | | | x | x | x | x |
| Quarter-pel cross | | | | x | x | |
| ⅛-pel cross | | | | | x | |

This search process ensures that the MVP candidate still keeps the same MV precision as indicated by the AMVR mode after TM process.

Template matching is applied to subblock based motion tools, including affine and SbTMVP modes. More specifically, for an affine merge candidate, the control point motion vectors (“CPMVs”) are refined using TM. A same MV offset is assigned to all the CPMVs, and the TM cost of the affine candidate is calculated accordingly. The optimal CPMV offset with the minimum TM cost can be used to refine the corresponding affine candidate, and a non-translation parameter refinement process is added to uni-predicted affine merge candidates. In the non-translation parameter refinement process, each CPMV is fixed as a base MV in turn, and an offset is added to the non-translation parameter of affine model by minimizing the template matching cost. Then, the other CPMVs are calculated according to based MV and refined non-translation parameters.

For a SbTMVP candidate, the initial motion shift is first refined with TM, and the refined motion shift is used to derive subblock temporal motion information. Then, the subblock MVs are further refined with TM. During the refinement, one top row and one left column are used as the template, and all the subblock MVs share the same MV offset.

Moreover, after the merge candidate list is constructed, the merge candidates are reordered according to adaptive reordering of merge candidates with template matching, hereinafter referred to as “ARMC-TM”, wherein merge candidates are adaptively reordered by TM. This reordering is applied to regular merge mode, TM merge mode, and subblock merge mode (excluding the first SbTMVP candidate). For TM merge mode, merge candidates are reordered before the refinement process.

An initial merge candidate list is first constructed according to given checking order, such as spatial neighboring coded blocks, TMVPs, non-adjacent blocks, HMVPs, pairwise candidates, and virtual merge candidates. The candidates in the initial list are divided into several subgroups. Merge candidates in each subgroup are reordered to generate a reordered merge candidate list and the reordering is according to cost values based on template matching. For TM merge mode and adaptive DMVR mode, each merge candidate in the initial list is first refined by TM/multi-pass DMVR. The index of selected merge candidate in the reordered merge candidate list is signaled to the decoder. For simplicity, merge candidates in the last but not the first subgroup are not reordered. All the zero candidates from the ARMC reordering process are excluded during the construction of a merge motion vector candidates list. The subgroup size is set to 5 for regular merge mode and TM merge mode, and is set to 3 for subblock merge mode.

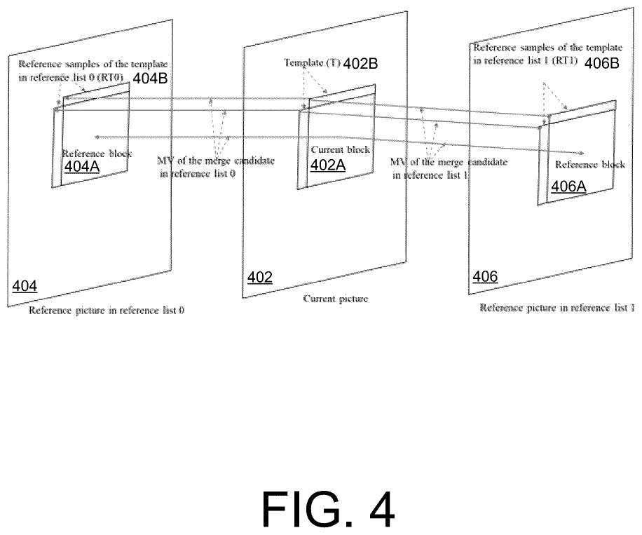

The template matching cost of a merge candidate during the reordering process is measured by the SAD between samples of a template of the current block and their corresponding reference samples. The template includes a set of reconstructed samples neighboring the current block. Reference samples of the template are located by the motion information of the merge candidate. When a merge candidate utilizes bi-directional prediction, the reference samples of the template of the merge candidate are also generated by bi-prediction as illustrated in FIG. 4.

FIG. 4 illustrates motion prediction performed upon a current picture 402 according to bi-prediction. The current picture 402 includes a current block 402A, which includes a template 402B. Reference samples of the template reference two co-located reference pictures 404 and 406, one from reference picture list 0 in a first temporal direction, and one from reference picture list 1 in a second temporal direction, in accordance with bi-prediction. Motion information of the current block 402A refers to a co-located reference block 404A of the co-located reference picture 404, and refers to a co-located reference block 406A of the co-located reference picture 406. The template 402B of the current block 402A refers to reference samples 404B of the co-located reference picture 404, and refers to reference samples 406B of the co-located reference picture 406.

When multi-pass DMVR is used to derive the refined motion to the initial merge candidate list, in the preliminary TM based refinement, only the first pass (i.e., PU level) of multi-pass DMVR is applied, and in the final TM based refinement, both PU level and subblock level of multi-pass DMVR are applied. When template matching is used to derive the refined motion, the template size is set equal to 1. Only the above or left template is used during the motion refinement of TM when the block is flat with block width greater than 2 times of height or narrow with height greater than 2 times of width. TM is extended to perform 1/16-pel MVD precision, and the first four merge candidates are reordered with the refined motion in TM merge mode.

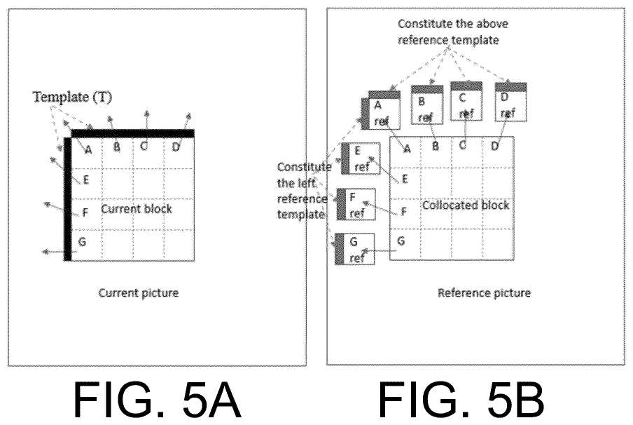

Given Wsub×Hsub as subblock size of an affine merge candidate, the upper template includes several sub-templates with the size of Wsub×1, and the left template includes several sub-templates with the size of 1×Hsub. As illustrated by FIGS. 5A and 5B, the motion information of the subblocks in the first row and the first column of current block is used to derive the reference samples of each sub-template.

In the reordering process, a candidate is considered as redundant if the cost difference between a candidate and its predecessor is inferior to a lambda value, e.g., |D1−D2|<λ, where D1 and D2 are the costs obtained during the first ARMC ordering, and λ is the Lagrangian parameter used in the RD criterion at encoder side.

Reordering proceeds as follows:

The minimum cost difference between a candidate and its predecessor among all candidates in the list is determined. If the minimum cost difference is superior or equal to λ, the list is considered sufficiently diverse and the reordering stops. If this minimum cost difference is inferior to λ, the candidate is considered as redundant, and it is moved at a further position in the list. This further position is the first position where the candidate is sufficiently diverse compared to its predecessor.

This is repeated for a finite number of iterations, while the minimum cost difference is not inferior to λ.

Such reordering steps are applied to the regular, TM, BM and subblock merge modes. Similar reordering is applied to the Merge MMVD and sign MVD prediction methods, which also use ARMC for the reordering.

The value of λ is set equal to the λ of the rate distortion criterion used to select the best merge candidate at the encoder side for low delay configuration, and to the value λ corresponding to another QP for Random Access configuration. A set of λ values corresponding to each signaled QP offset is provided in the SPS or in the Slice Header for the QP offsets which are not present in the SPS.

The ARMC-TM design is also applicable to the AMVP mode wherein the AMVP candidates are reordered according to the TM cost. For the template matching for advanced motion vector prediction (“TM-AMVP”) mode, an initial AMVP candidate list is constructed, followed by a refinement from TM to construct a refined AMVP candidate list. In addition, an MVP candidate with a TM cost larger than a threshold, which is equal to five times of the cost of the first MVP candidate, is skipped.

When wraparound motion compensation is enabled, the MV candidate shall be clipped with wraparound offset taken into consideration.

According to template matching-based overlapped block motion compensation (“OBMC”), instead of directly using the weighted prediction, the prediction value of CU boundary samples derivation approach is decided according to the template matching costs, including using current block's motion information only, or using neighboring block's motion information as well with one of the blending modes.

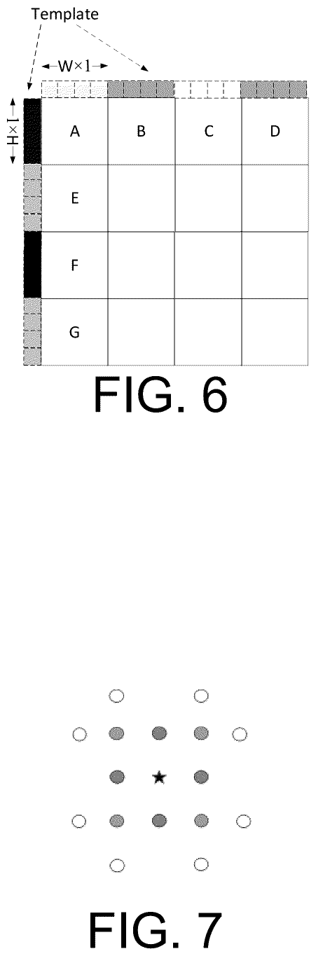

FIG. 6 illustrates templates applied according to OBMC. In this scheme, for each block with a size of 4×4 at the top CU boundary, an upper template size is 4×1. If N adjacent blocks have the same motion information, then the upper template size is enlarged to 4N×1 since the motion compensation (“MC”) operation can be processed at one time. For each left block with a size of 4×4 at the left CU boundary, the left template size is 1×4 or 1×4N.

For each 4×4 top block (or N 4×4 blocks group), the prediction value of boundary samples is derived following the below steps.

Take block A as the current block and its above neighboring block AboveNeighbor_A for example. The operation for left blocks is conducted in the same manner.

First, three template matching costs (Cost1, Cost2, Cost3) are measured by SAD between the reconstructed samples of a template and its corresponding reference samples derived by MC process according to the following three types of motion information:

Cost1 is calculated according to A's motion information.

Cost2 is calculated according to AboveNeighbor_A's motion information.

Cost3 is calculated according to weighted prediction of A's and AboveNeighbor_A's motion information with weighting factors as ¾ and ¼ respectively.

Second, choose one approach to calculate the final prediction results of boundary samples by comparing Cost1, Cost2 and Cost3.

The original MC result using current block's motion information is denoted as Pixel1, and the MC result using neighboring block's motion information is denoted as Pixel2. The final prediction result is denoted as NewPixel.

If Cost1 is minimum, then NewPixel(i, j)=Pixel1(i, j).

If (Cost2+(Cost2>>2)+(Cost2>>3))<=Cost1, then blending mode 1 is used.

For luma blocks, the number of blending pixel rows is 4, yielded by Equations 11, 12, 13, and 14 below:

$$\begin{matrix}NewPixel ( i , 0 ) = ( 26 \times Pixel 1 ( i , 0 ) + 6 \times P i x e l 2 ( i , 0 ) + 16 ) ≫ 5 \\ NewPixel ( i , 1 ) = ( 7 \times Pixel 1 ( i , 1 ) + P i x e l 2 ( i , 1 ) + 4 ) ≫ 3 \\ NewPixel ( i , 2 ) = ( 15 \times Pixel 1 ( i , 2 ) + P i x e l 2 ( i , 2 ) + 8 ) ≫ 4 \\ NewPixel ( i , 3 ) = ( 31 \times Pixel 1 ( i , 3 ) + P i x e l 2 ( i , 3 ) + 16 ) ≫ 5\end{matrix}$$

For chroma blocks, the number of blending pixel rows is 1, yielded by Equation 15 below:

$$NewPixel ( i , 0 ) = ( 26 \times Pixel 1 ( i , 0 ) + 6 \times Pixel 2 ( i , 0 ) + 16 ) ≫ 5$$

If Cost1<=Cost2, then blending mode 2 is used.

For luma blocks, the number of blending pixel rows is 2, yielded by Equations 16 and 17 below:

$$\begin{matrix}NewPixel ( i , 0 ) = ( 15 \times Pixel 1 ( i , 0 ) + P i x e l 2 ( i , 0 ) + 8 ) ≫ 4 \\ NewPixel ( i , 1 ) = ( 31 \times Pixel 1 ( i , 1 ) + P i x e l 2 ( i , 1 ) + 16 ) ≫ 5\end{matrix}$$

For chroma blocks, the number of blending pixel rows/columns is 1, yielded by Equation 18 below:

$$NewPixel ( i , 0 ) = ( 15 \times Pixel 1 ( i , 0 ) + P i x e l 2 ( i , 0 ) + 8 ) ≫ 4$$

Otherwise, blending mode 3 is used.

For luma blocks, the number of blending pixel rows is 4, yielded by Equations 19, 20, and 21 below:

$$\begin{matrix}NewPixel ( i , 1 ) = ( 7 \times Pixel 1 ( i , 1 ) + P i x e l 2 ( i , 1 ) + 4 ) ≫ 3 \\ NewPixel ( i , 2 ) = ( 15 \times Pixel 1 ( i , 2 ) + P i x e l 2 ( i , 2 ) + 8 ) ≫ 4 \\ NewPixel ( i , 3 ) = ( 31 \times Pixel 1 ( i , 3 ) + P i x e l 2 ( i , 3 ) + 16 ) ≫ 5\end{matrix}$$

For chroma blocks, the number of blending pixel rows is 1, yielded by Equation 22 below:

$$NewPixel ( i , 0 ) = ( 7 \times Pixel 1 ( i , 0 ) + P i x e l 2 ( i , 0 ) + 4 ) ≫ 3$$

MMVD offsets are extended for MMVD and affine MMVD modes. FIG. 7 illustrates additional refinement positions along k×π/8 diagonal angles, thus increasing the number of directions from 4 to 16. Second, based on the SAD cost between the template (one row above and one column left to the current block) and its reference for each refinement position, all the possible MMVD refinement positions (16×6) for each base candidate are reordered. Finally, the ⅛ refinement positions with the smallest template SAD costs are kept as available positions, consequently for MMVD index coding. The MMVD index is binarized by the Golomb-Rice code with the parameter equal to 2. The affine MMVD reordering is extended, in which additional refinement positions along k×π/4 diagonal angles are added. After reordering, the ½ refinement positions with the smallest template SAD costs are kept.

The first N motion candidates in the candidate list before being reordered are utilized as the base candidates for MMVD and affine MMVD. N is equal to 3 for MMVD, and [1, 3] depending on the neighboring block affine flags for affine MMVD. Two ways of adding MMVD offsets are allowed, including “two-side” and “one-side,” depending on whether the offset of the other reference picture list is mirrored or directly set to zero. Which way is applied to one block is dependent on the TM cost.

Geometric partitioning modes (“GPMs”) are signaled using a CU-level flag as one kind of merge mode among other possible merge modes including the regular merge mode, merge with motion difference (“MMVD”) mode, combined inter-intra prediction (“CIIP”) mode and the subblock merge mode. In total, 64 partitions are supported by geometric partitioning mode for each possible CU size, excluding 8×64 and 64×8.

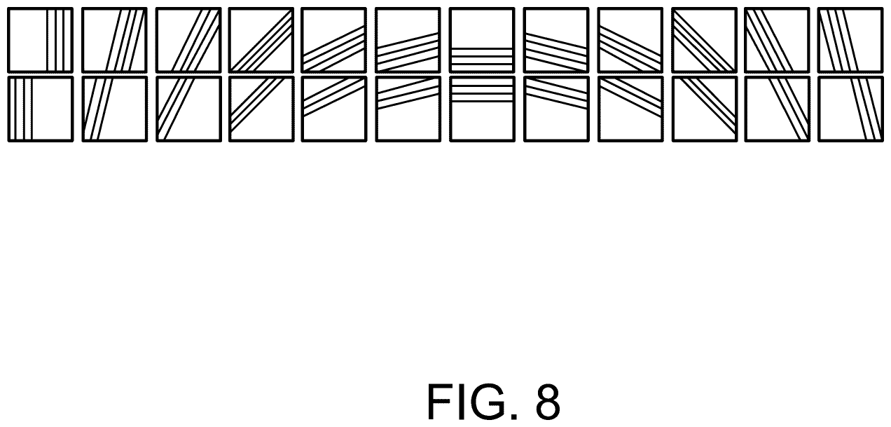

According to prediction by GPM, a CU is geometrically partitioned, i.e., split into two parts by a geometrically located straight line. FIG. 8 illustrates classifications of geometric partitions by their respective angles. For each classification, the splitting line always has the same angle but can be at various different coordinates, where each classification is illustrated showing, by way of example, three among many possible coordinates.

The location of the splitting line is mathematically derived from the angle and offset parameters of a specific partition. Each part of a geometric partition in the CU is inter-predicted using its own motion.

When GPM mode is enabled for a CU, a CU-level flag is signaled to indicate whether template matching is applied to both geometric partitions. Motion information for each geometric partition is refined using template matching. When template matching is chosen, a template is constructed using left neighboring samples, above neighboring samples, or both left and above neighboring samples according to partition angle, according to Table 2 below.

| Partition angle | 0 | 2 | 3 | 4 | 5 | 8 | 11 | 12 | 13 | 14 |
|---|---|---|---|---|---|---|---|---|---|---|
| 1^{st} partition | A | A | A | A | L + A | L + A | L + A | L + A | A | A |
| 2^{nd} partition | L + A | L + A | L + A | L | L | L | L | L + A | L + A | L + A |
| Partition angle | 16 | 18 | 19 | 20 | 21 | 24 | 27 | 28 | 29 | 30 |
| 1^{st} partition | A | A | A | A | L + A | L + A | L + A | L + A | A | A |
| 2^{nd} partition | L + A | L + A | L + A | L | L | L | L | L + A | L + A | L + A |

The motion is then refined by minimizing the difference between the current template and the template in the reference picture using the same search pattern of merge mode with half-pel interpolation filter disabled.

Then, a GPM candidate list is constructed. First, MV candidates for list 0 and list 1 are derived directly from a regular merge candidate list and interleaved. List 0 candidates are higher priority candidates than list 1 candidates. Pruning with an adaptive threshold based on the current CU size is applied to these interleaved list 0 and list 1 MV candidates to remove redundant MV candidates. Then, further list 0 and list 1 candidates are derived from the regular merge candidate list, but list 1 MV candidates are higher-priority than list 0 MV candidates. The same pruning method with the same adaptive threshold is then applied once more to remove redundant MV candidates. Finally, Zero MV candidates are padded until the GPM candidate list is full.

One GPM CU cannot use both MMVD and TM with GPM; GPM with MMVD (“GPM-MMVD”) and GPM with TM (“GPM-TM”) are mutually exclusive. Therefore, syntax for signaling a GPM CU includes two GPM-MMVD flags and optionally includes a GPM-TM flag following the GPM-MMVD flags. When both two GPM-MMVD control flags are equal to false (i.e., the GPM-MMVD are disabled for two GPM partitions), the GPM-TM flag is signaled to indicate whether the template matching is applied to the two GPM partitions. Otherwise (i.e., at least one GPM-MMVD flag is equal to true), the value of the GPM-TM flag is inferred to be false.

According to TM-based reordering for GPM split modes, template matching is performed by searching, in a predefined search range, based on an L-shaped template of the current block, for an L-shaped template in a reference picture having the least difference from the template of the current block (expressed by lowest cost according to a cost function). Given the motion information of the current GPM block, the respective template matching cost values of GPM split modes are computed. Then, all GPM split modes are reordered in order of ascending TM cost values. Instead of sending GPM split mode, an index is signaled using Golomb-Rice code to indicate where the exact GPM split mode located in the reordering list.

GPM split mode reordering is a two-step process performed after generating the respective reference templates of the two GPM partitions in a CU. The first step is extending GPM partition splitting line into the reference templates of the two GPM partitions, resulting in 64 reference templates and computing the respective TM cost for each of the 64 reference templates. The second step is reordering GPM split modes based on their TM cost values in ascending order and marking the best 32 split modes as available split modes.

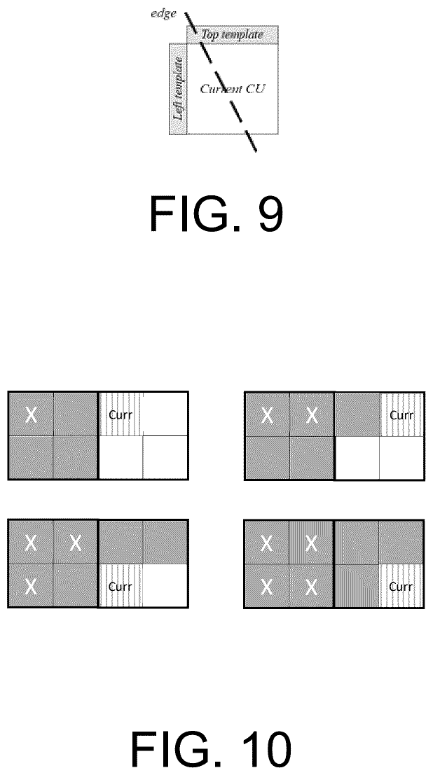

The splitting line over the template is extended from that of the current CU. FIG. 9 illustrates an example of extending a partition splitting line of a current CU. However, the GPM blending process is not applied in the template area across the splitting line. After reordering by ascending TM cost, an index is signaled using Golomb-Rice code (with divisor 4) to indicate the use of GPM split mode.

TM is used in IBC for both IBC merge mode (intra block copy with template matching, or “IBC-TM”) and IBC AMVP mode.

The IBC-TM merge list is modified compared to the one used by regular IBC merge mode such that the candidates are selected according to a pruning method with a motion distance between the candidates as in the regular TM merge mode. The ending zero motion fulfillment is replaced by motion vectors to the left (−W, 0), top (0, −H) and top-left (−W, −H), where W is the width and H the height of the current CU.

According to IBC-TM merge mode, the selected candidates are refined by TM prior to RDO or the decoding process. A TM-merge flag is signaled to select between applying IBC-TM merge mode and applying regular IBC merge mode.

According to IBC-TM AMVP mode, up to three candidates are selected from the IBC-TM merge list. Each of those three selected candidates are refined by TM and sorted according to their resulting TM cost. Only the first two candidates are then considered in the motion estimation process as usual.

According to TM refinement for both IBC-TM merge and AMVP modes, IBC motion vectors are constrained to (i) integers and (ii) within a reference region as illustrated in FIG. 10. Thus, for IBC-TM merge mode, all refinements are performed at integer precision, and for IBC-TM AMVP mode, they are performed either at integer or 4-pel precision depending on the AMVR value. Such a refinement accesses only samples without interpolation. In both cases, the refined motion vectors and the template applied in each refinement step respect the reference region constraint.

According to VVC and later standards, MV precision is increased to 1/16 luma sample, to improve the prediction efficiency of slow motion video. This higher motion accuracy is particularly helpful for video contents with locally varying and non-translational motion such as in case of affine mode. For fractional position samples generation of higher MV accuracy, HEVC 8-tap luma interpolation filters and 4-tap chroma interpolation filters are extended to 16 phases for luma and 32 phases for chroma. This extended filter set is applied in MC process of inter coded CUs except the CUs in affine mode. For affine mode, a set of 6-tap luma interpolation filter with 16 phases is used for lower computational complexity as well as memory bandwidth saving.

For luma interpolation in ECM, the 8-tap interpolation filter provided by VVC and later standards is replaced with a 12-tap filter. The interpolation filter is derived from the sine function of which the frequency response is cut off at Nyquist frequency and cropped by a cosine window function. Table 3 gives the filter coefficients of all 16 phases.

| | | | | | | | | | | | | |
|---|---|---|---|---|---|---|---|---|---|---|---|---|
| 1/16 | −1 | 2 | −3 | 6 | −14 | 254 | 16 | −7 | 4 | −2 | 1 | 0 |
| 2/16 | −1 | 3 | −7 | 12 | −26 | 249 | 35 | −15 | 8 | −4 | 2 | 0 |
| 3/16 | −2 | 5 | −9 | 17 | −36 | 241 | 54 | −22 | 12 | −6 | 3 | −1 |
| 4/16 | −2 | 5 | −11 | 21 | −43 | 230 | 75 | −29 | 15 | −8 | 4 | −1 |
| 5/16 | −2 | 6 | −13 | 24 | −48 | 216 | 97 | −36 | 19 | −10 | 4 | −1 |
| 6/16 | −2 | 7 | −14 | 25 | −51 | 200 | 119 | −42 | 22 | −12 | 5 | −1 |
| 7/16 | −2 | 7 | −14 | 26 | −51 | 181 | 140 | −46 | 24 | −13 | 6 | −2 |
| 8/16 | −2 | 6 | −13 | 25 | −50 | 162 | 162 | −50 | 25 | −13 | 6 | −2 |
| 9/16 | −2 | 6 | −13 | 24 | −46 | 140 | 181 | −51 | 26 | −14 | 7 | −2 |
| 10/16 | −1 | 5 | −12 | 22 | −42 | 119 | 200 | −51 | 25 | −14 | 7 | −2 |
| 11/16 | −1 | 4 | −10 | 19 | −36 | 97 | 216 | −48 | 24 | −13 | 6 | −2 |
| 12/16 | −1 | 4 | −8 | 15 | −29 | 75 | 230 | −43 | 21 | −11 | 5 | −2 |
| 13/16 | −1 | 3 | −6 | 12 | −22 | 54 | 241 | −36 | 17 | −9 | 5 | −2 |
| 14/16 | 0 | 2 | −4 | 8 | −15 | 35 | 249 | −26 | 12 | −7 | 3 | −1 |
| 15/16 | 0 | 1 | −2 | 4 | −7 | 16 | 254 | −14 | 6 | −3 | 2 | −1 |

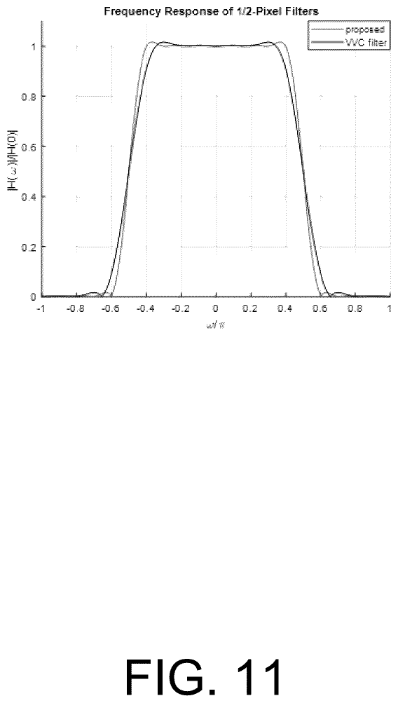

FIG. 11 illustrates frequency responses of the interpolation filters compared to frequency responses of the VVC and later standard interpolation filter, all at half-pel phase.

For bi-predicted blocks with width and height both greater than four, a sharp motion compensation filter is used. The sharp motion compensation filter is derived from a generalized form of cos-windowed sinc by Equation 23 below, where a and b have been selected to be slightly lower than 1 (instead of equal to 1) and where A is a scaling factor to provide the desired number of filter taps.

$$f ( x ) = {cos}^{a} ( Ax ) sin c ( \frac{x}{b} )$$

Filter coefficients are given in Table 4 below.

| | | | | | | | | | | | | |
|---|---|---|---|---|---|---|---|---|---|---|---|---|
| 1/16 | −1 | 3 | −5 | 8 | −16 | 256 | 15 | −6 | 3 | −1 | 0 | 0 |
| 2/16 | −2 | 5 | −9 | 15 | −30 | 253 | 32 | −12 | 5 | −2 | 1 | 0 |
| 3/16 | −3 | 7 | −12 | 21 | −40 | 244 | 50 | −18 | 9 | −4 | 2 | 0 |
| 4/16 | −3 | 8 | −15 | 25 | −48 | 235 | 71 | −25 | 12 | −6 | 2 | 0 |
| 5/16 | −3 | 9 | −16 | 28 | −53 | 220 | 93 | −32 | 16 | −8 | 3 | −1 |
| 6/16 | −3 | 8 | −16 | 28 | −54 | 204 | 116 | −39 | 19 | −10 | 4 | −1 |
| 7/16 | −2 | 8 | −15 | 27 | −53 | 183 | 139 | −45 | 22 | −12 | 5 | −1 |
| 8/16 | −2 | 6 | −13 | 25 | −50 | 162 | 162 | −50 | 25 | −13 | 6 | −2 |
| 9/16 | −1 | 5 | −12 | 22 | −45 | 139 | 183 | −53 | 27 | −15 | 8 | −2 |
| 10/16 | −1 | 4 | −10 | 19 | −39 | 116 | 204 | −54 | 28 | −16 | 8 | −3 |
| 11/16 | −1 | 3 | −8 | 16 | −32 | 93 | 220 | −53 | 28 | −16 | 9 | −3 |
| 12/16 | 0 | 2 | −6 | 12 | −25 | 71 | 235 | −48 | 25 | −15 | 8 | −3 |
| 13/16 | 0 | 2 | −4 | 9 | −18 | 50 | 244 | −40 | 21 | −12 | 7 | −3 |
| 14/16 | 0 | 1 | −2 | 5 | −12 | 32 | 253 | −30 | 15 | −9 | 5 | −2 |
| 15/16 | 0 | 0 | −1 | 3 | −6 | 15 | 256 | −16 | 8 | −5 | 3 | −1 |

For chroma interpolation in ECM, the 4-tap interpolation filter used in VVC and later standards is replaced with a 6-tap filter. Filter coefficients are given in Table 5 below.

| Fractional position | Coefficients (6 taps) |
|---|---|
| 1/32 | {0, 0, 256, 0, 0, 0}, |
| 2/32 | {1, −6, 256, 7, −2, 0}, |
| 3/32 | {2, −11, 253, 15, −4, 1}, |
| 4/32 | {3, −16, 251, 23, −6, 1}, |
| 5/32 | {4, −21, 248, 33, −10, 2}, |
| 6/32 | {5, −25, 244, 42, −12, 2}, |
| 7/32 | {7, −30, 239, 53, −17, 4}, |
| 8/32 | {7, −32, 234, 62, −19, 4}, |
| 6/32 | {8, −35, 227, 73, −22, 5}, |
| 7/32 | {9, −38, 220, 84, −26, 7}, |
| 8/32 | {10, −40, 213, 95, −29, 7}, |
| 9/32 | {10, −41, 204, 106, −31, 8}, |
| 10/32 | {10, −42, 196, 117, −34, 9}, |
| 11/32 | {10, −41, 187, 127, −35, 8}, |
| 12/32 | {11, −42, 177, 138, −38, 10}, |
| 13/32 | {10, −41, 168, 148, −39, 10}, |
| 14/32 | {10, −40, 158, 158, −40, 10}, |
| 15/32 | {10, −39, 148, 168, −41, 10}, |
| 16/32 | {10, −38, 138, 177, −42, 11}, |
| 17/32 | {8, −35, 127, 187, −41, 10}, |
| 18/32 | {9, −34, 117, 196, −42, 10}, |
| 19/32 | {8, −31, 106, 204, −41, 10}, |
| 20/32 | {7, −29, 95, 213, −40, 10}, |
| 21/32 | {7, −26, 84, 220, −38, 9}, |
| 22/32 | {5, −22, 73, 227, −35, 8}, |
| 23/32 | {4, −19, 62, 234, −32, 7}, |
| 24/32 | {4, −17, 53, 239, −30, 7}, |
| 25/32 | {2, −12, 42, 244, −25, 5}, |
| 26/32 | {2, −10, 33, 248, −21, 4}, |
| 27/32 | {1, −6, 23, 251, −16, 3}, |
| 28/32 | {1, −4, 15, 253, −11, 2}, |
| 31/32 | {0, −2, 7, 256, −6, 1}, |

According to VVC and later standards, the resolution of the MVs is 1/16 luma samples. The samples at the fractional position are interpolated using a 8-tap interpolation filter. In DMVR, the search points are surrounding the initial fractional-pel MV with integer sample offset, therefore the samples of those fractional position need to be interpolated for DMVR search process.

To reduce computational complexity, the bilinear interpolation filter is used to generate the fractional samples for the searching process in DMVR. Filter coefficients are given in Table 6 below, where the precision of coefficients is in 4-bit.

| Fractional position | Coefficients (2 tap) |
|---|---|
| 1/16 | {15, 1}, |
| 2/16 | {14, 2}, |
| 3/16 | {13, 3}, |
| 4/16 | {12, 4}, |
| 5/16 | {11, 5}, |
| 6/16 | {10, 6}, |
| 7/16 | {9, 7}, |
| 8/16 | {8, 8}, |
| 9/16 | {7, 9}, |
| 10/16 | {6, 10}, |
| 11/16 | {5, 11}, |
| 12/16 | {4, 12}, |
| 13/16 | {3, 13}, |
| 14/16 | {2, 14}, |
| 15/16 | {1, 15} |

Moreover, by using a bilinear filter, with a 2-sample search range, DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

For template matching-based methods, the samples of those fractional position in the template area (i.e., top and/or left neighboring blocks of the current CU) in the current picture and a block (i.e., same size to the template) in a reference picture also need to be interpolated for TM searching.

Another bilinear interpolation filter is used to generate the fractional samples for the searching process in TM. Filter coefficients are given in in Table 7 below, where the precision of coefficients is in 8-bit.

| Fractional position | Coefficients (2 tap) |
|---|---|
| 1/16 | {240, 16}, |
| 2/16 | {224, 32}, |
| 3/16 | {208, 48}, |
| 4/16 | {192, 64}, |
| 5/16 | {176, 80}, |
| 6/16 | {160, 96}, |
| 7/16 | {144, 112}, |
| 8/16 | {128, 128}, |
| 9/16 | {112, 144}, |
| 10/16 | {96, 160}, |
| 11/16 | {80, 176}, |
| 12/16 | {64, 192}, |
| 13/16 | {48, 208}, |
| 14/16 | {32, 224}, |
| 15/16 | {16, 240}, |

According to the above techniques specified according to VVC and later standards, MC filtering in video coding standards is typically implemented using fixed Finite Impulse Response (“FIR”) filters. Increasing the number of taps in an interpolation filter can reduce artifacts and distortion during the interpolation, and ultimately improve the coding performance. Therefore, according to ECM, the 8-tap luma interpolation filter used in VVC and later standards is replaced by a 12-tap filter. Also, the 4-tap chroma interpolation filter used in VVC and later standards is replaced by a 6-tap filter. However, the interpolation filters used in template matching and DMVR search process are still unchanged with only 2-tap coefficients.

Therefore, example embodiments of the present disclosure provide three higher tap-length interpolation filters for template matching-based tools and DMVR to generate the fractional samples.

According to example embodiments of the present disclosure, a first interpolation filter is derived by discrete cosine transform-based interpolation filter (“DCT-IF”). The first interpolation filter is a 4-tap filter with 8-bit coefficients precision and 16 phases, and filter coefficients of the first interpolation filter are given in Table 8 below.

| Fractional position | Coefficients (4 tap) |
|---|---|
| 1/16 | {−8, 248, 16, 0} |
| 2/16 | {−8, 232, 40, −8} |
| 3/16 | {−16, 224, 56, −8} |
| 4/16 | {−16, 216, 64, −8} |
| 5/16 | {−24, 208, 80, −8} |
| 6/16 | {−24, 184, 112, −16} |
| 7/16 | {−16, 168, 120, −16} |
| 8/16 | {−16, 144, 144, −16} |
| 9/16 | {−16, 120, 168, −16} |
| 10/16 | {−16, 112, 184, −24} |
| 11/16 | {−8, 80, 208, −24} |
| 12/16 | {−8, 64, 216, −16} |
| 13/16 | {−8, 56, 224, −16} |
| 14/16 | {−8, 40, 232, −8} |
| 15/16 | {0, 16, 248, −8} |

A second interpolation filter is derived by a cubic-based interpolation filter. The second interpolation filter is a 4-tap filter with 8-bit coefficients precision and 16 phases, and filter coefficients of the second filter are given in Table 9 below.

| Fractional position | Coefficients (4 tap) |
|---|---|
| 1/16 | {−5, 247, 17, −3} |
| 2/16 | {−9, 236, 34, −5} |
| 3/16 | {−12, 224, 52, −8} |
| 4/16 | {−14, 210, 70, −10} |
| 5/16 | {−16, 195, 89, −12} |
| 6/16 | {−16, 179, 107, −14} |
| 7/16 | {−17, 162, 126, −15} |
| 8/16 | {−16, 144, 144, −16} |
| 9/16 | {−15, 126, 162, −17} |
| 10/16 | {−14, 107, 179, −16} |
| 11/16 | {−12, 89, 195, −16} |
| 12/16 | {−10, 70, 210, −14} |
| 13/16 | {−8, 52, 224, −12} |
| 14/16 | {−5, 34, 236, −9} |
| 15/16 | {−3, 17, 247, −5} |

A third interpolation filter is also derived by a cubic-based interpolation filter. The third filter is a 4-tap filter with 8-bit coefficients precision and 16 phases, and filter coefficients of the third filter are given in Table 10 below.

| Fractional position | Coefficients (4 tap) |
|---|---|
| 1/16 | {−12, 260, 12, −4} |
| 2/16 | {−16, 252, 24, −4} |
| 3/16 | {−20, 240, 44, −8} |
| 4/16 | {−24, 228, 64, −12} |
| 5/16 | {−28, 216, 84, −16} |
| 6/16 | {−24, 192, 104, −16} |
| 7/16 | {−24, 172, 128, −20} |
| 8/16 | {−20, 148, 148, −20} |
| 9/16 | {−20, 128, 172, −24} |
| 10/16 | {−16, 104, 192, −24} |
| 11/16 | {−16, 84, 216, −28} |
| 12/16 | {−12, 64, 228, −24} |
| 13/16 | {−8, 44, 240, −20} |
| 14/16 | {−4, 24, 252, −16} |
| 15/16 | {−4, 12, 260, −12} |

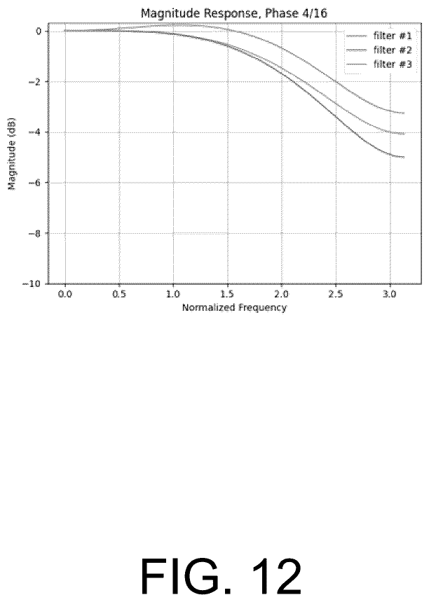

FIG. 12 illustrates magnitude responses of the three higher tap-length interpolation filters (e.g., 4/16 phase) according to example embodiments of the present disclosure.

According to an example embodiment of the present disclosure, when a coding unit is coded in any template matching-based mode (including, without limitation thereto, TM merge, TM AMVP, ARMC-TM, TM-OBMC, TM-MMVD, TM-GPM, IBC-TM, and the like), or a coding unit is coded in DMVR mode, a parameter (e.g., a flag) is signaled to indicate whether a higher tap-length interpolation filter is applied or not. When a higher tap-length interpolation filter is applied, in the template area of the current picture and reference picture, the samples of the fractional positions of the interpolation filter will be interpolated for a template matching-based mode, or the fractional samples in the DMVR searching process will be interpolated by a higher tap-length interpolation filter. Table 11 below illustrates an example of the above-described parameter syntax.

| Signaled parameter | Syntax |
|---|---|
| 0 | Higher tap-length interpolation filter not applied |
| 1 | Higher tap-length interpolation filter applied for TM |
| | and DMVR |

When a higher tap-length interpolation filter is not applied, the original 2-tap bilinear filters will be used for interpolation.

According to another example embodiment of the present disclosure, to provide flexibility, higher tap-length interpolation filters are independently applied for TM and DMVR. A first parameter (e.g., a first flag) is signaled to indicate whether a higher tap-length interpolation filter is applied for TM based mode. A second parameter (e.g., a second flag) is signaled to indicate whether a higher tap-length interpolation filter is applied for DMVR searching. Table 12 below illustrates an example of the above-described parameter syntax.

| First signaled | Second signaled | |
|---|---|---|
| parameter | parameter | Syntax |
| 0 | 0 | Higher tap-length interpolation filter not applied |
| 0 | 1 | Higher tap-length interpolation filter applied for |
| | | DMVR |
| 1 | 0 | Higher tap-length interpolation filter applied for TM |
| 1 | 1 | Higher tap-length interpolation filter applied for TM |
| | | and DMVR |

According to another example embodiment of the present disclosure, if a higher tap-length interpolation filter is applied, each of the interpolation filters is signaled by a different parameter. For example, an index is signaled: when the index is equal to 0, the above-mentioned first interpolation filter is used; when the index is equal to 1, the above-mentioned second interpolation filter is used; and when the index is equal to 2, the above-mentioned third interpolation filter is used. The parameter syntax is not limited to signaling three interpolation filters, as the index of the filters depends on the number of filters signaled. Table 13 below illustrates an example of the above-described parameter syntax.

| Index | Syntax |
|---|---|
| 0 | First higher tap-length interpolation filter is used |
| 1 | Second higher tap-length interpolation filter is used |
| 2 | Third higher tap-length interpolation filter is used |
| . . . | . . . |

According to another example embodiment of the present disclosure, a VVC and later standard encoder and a VVC and later standard decoder implements a higher tap-length interpolation filter replacing bilinear filters for template matching-based mode, without any signaling.

According to another example embodiment of the present disclosure, a VVC and later standard encoder and a VVC and later standard decoder implements a higher tap-length interpolation filter replacing bilinear filters for DMVR mode, without any signaling.

According to another example embodiment of the present disclosure, to reduce computational complexity, a higher tap-length interpolation filter is used in inter template matching-based mode but not IBC template matching-based mode (i.e., IBC-TM).

According to another example embodiment, to reduce computational complexity, a higher tap-length interpolation filter is used in ARMC.

In the aforementioned embodiments, the parameters, flags, or indices can be signaled at SPS, PPS, picture header, slice header, CTU, CU, PU or TU level.

The aforementioned embodiments can be combined freely. By way of example, a higher tap-length interpolation filter is always used in template matching-based mode, and the bilinear filter is used in DMVR. By way of another example, a higher tap-length interpolation filter is always used in template matching-based mode, and one parameter is signed to indicate which filter is used in DMVR.

Persons skilled in the art will appreciate that all of the above aspects of the present disclosure may be implemented concurrently in any combination thereof, and all aspects of the present disclosure may be implemented in combination as yet another embodiment of the present disclosure.

FIG. 13 illustrates an example system 1300 for implementing the processes and methods described above for implementing interpolation filters for template matching and DMVR.

The techniques and mechanisms described herein may be implemented by multiple instances of the system 1300 as well as by any other computing device, system, and/or environment. The system 1300 shown in FIG. 13 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 1300 may include one or more processors 1302 and system memory 1304 communicatively coupled to the processor(s) 1302. The processor(s) 1302 may execute one or more modules and/or processes to cause the processor(s) 1302 to perform a variety of functions. In some embodiments, the processor(s) 1302 may include a central processing unit (“CPU”), a graphics processing unit (“GPU”), both CPU and GPU, or other processing units or components known in the art. Additionally, each of the processor(s) 1302 may possess its own local memory, which also may store program modules, program data, and/or one or more operating systems.

Depending on the exact configuration and type of the system 1300, the system memory 1304 may be volatile, such as RAM, non-volatile, such as ROM, flash memory, miniature hard drive, memory card, and the like, or some combination thereof. The system memory 1304 may include one or more computer-executable modules 1306 that are executable by the processor(s) 1302.

The modules 1306 may include, but are not limited to, one or more of an encoder 1308 and a decoder 1310.

The encoder 1308 may be a VVC and later standard encoder implementing any, some, or all aspects of example embodiments of the present disclosure as described above, and executable by the processor(s) 1302 to configure the processor(s) 1302 to perform operations as described above.

The decoder 1310 may be a VVC and later standard encoder implementing any, some, or all aspects of example embodiments of the present disclosure as described above, executable by the processor(s) 1302 to configure the processor(s) 1302 to perform operations as described above.

The system 1300 may additionally include an input/output (“I/O”) interface 1340 for receiving image source data and bitstream data, and for outputting reconstructed pictures into a reference picture buffer or DPB and/or a display buffer. The system 1300 may also include a communication module 1350 allowing the system 1300 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium 1330, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient or non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transient or non-transitory computer-readable storage media that, when executed by one or more processors, may perform operations described above with reference to FIGS. 1A-12s. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computing system to encode a video sequence to a bitstream, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
performing motion prediction by one of a template matching (“TM”)-based mode and decoder-side motion vector refinement (“DMVR”) search upon a coding unit (“CU”);
applying an interpolation filter having higher tap-length than a bilinear filter at fractional positions of the CU to generate fractional samples; and
encode a coded picture comprising the CU in a bitstream.

2. The computing system of claim 1, wherein the interpolation filter having higher tap-length than a bilinear filter is derived by a discrete cosine transform-based interpolation filter.

3. The computing system of claim 1, wherein the interpolation filter having higher tap-length than a bilinear filter is derived by a cubic-based interpolation filter.

4. The computing system of claim 1, wherein the operations further comprise:
transmitting a parameter in the bitstream, the parameter signaling whether to apply the interpolation filter having higher tap-length than a bilinear filter to both a CU coded by a TM-based mode and a CU signaled by DMVR search.

5. The computing system of claim 1, wherein the operations further comprise:
transmitting a first parameter in the bitstream, the first parameter signaling whether to apply the interpolation filter having higher tap-length than a bilinear filter to a CU coded by DMVR search.

6. The computing system of claim 5, wherein the operations further comprise:
transmitting a second parameter in the bitstream, the second parameter signaling whether to apply the interpolation filter having higher tap-length than a bilinear filter to a CU coded by a TM-based mode.

7. The computing system of claim 1, wherein the operations further comprise:
transmitting an index in the bitstream, the index signaling to apply one among a plurality of interpolation filters having higher tap-length than a bilinear filter to a CU coded by one of a TM-based mode and DMVR search.

8. The computing system of claim 1, wherein the interpolation filter having higher tap-length than a bilinear filter is applied without transmitting a parameter in the bitstream signaling whether to apply the interpolation filter having higher tap-length than a bilinear filter.

9. A computing system to decode a video sequence from a bitstream, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
performing motion prediction upon a CU coded by one of a template matching-based mode and decoder-side motion vector refinement (“DMVR”) search; and
applying an interpolation filter having higher tap-length than a bilinear filter at fractional positions of the CU to generate fractional samples.

10. The computing system of claim 9, wherein the interpolation filter having higher tap-length than a bilinear filter is derived by a discrete cosine transform-based interpolation filter.

11. The computing system of claim 9, wherein the interpolation filter having higher tap-length than a bilinear filter is derived by a cubic-based interpolation filter.

12. The computing system of claim 9, wherein the operations further comprise:
decoding a parameter from the bitstream, the parameter signaling whether to apply the interpolation filter having higher tap-length than a bilinear filter to a CU coded by a TM-based mode or by DMVR search.

13. The computing system of claim 9, wherein the operations further comprise:
decoding a first parameter from the bitstream, the first parameter signaling whether to apply the interpolation filter having higher tap-length than a bilinear filter to a CU coded by DMVR search.

14. The computing system of claim 13, wherein the operations further comprise:
decoding a second parameter from the bitstream, the second parameter signaling whether to apply the interpolation filter having higher tap-length than a bilinear filter to a CU coded by a TM-based mode.

15. The computing system of claim 9, wherein the operations further comprise:
decoding an index from the bitstream, the index signaling to apply one among a plurality of interpolation filters having higher tap-length than a bilinear filter to a CU coded by one of a TM-based mode and DMVR search.

16. The computing system of claim 9, wherein the interpolation filter having higher tap-length than a bilinear filter is applied without decoding a parameter in the bitstream signaling whether to apply the interpolation filter having higher tap-length than a bilinear filter.

17. A method of storing a bitstream associated with a video sequence, the method comprising:
generating a bitstream comprising:
one or more parameters signaling applying an interpolation filter having higher tap-length than a bilinear filter upon a CU coded by one of a template matching (“TM”)-based mode and decoder-side motion vector refinement (“DMVR”) search; and
storing the bitstream in a non-transitory computer-readable storage medium.

18. The method of claim 17, wherein the one or more parameters comprises a parameter signaling applying the interpolation filter having higher tap-length than a bilinear filter upon both a CU coded by a TM-based mode and a CU signaled by DMVR search.

19. The method of claim 17, wherein one or more parameters comprises a first parameter signaling applying the interpolation filter having higher tap-length than a bilinear filter upon a CU coded by DMVR search and a second parameter signaling applying the interpolation filter having higher tap-length than a bilinear filter upon a CU coded by a TM-based mode.

20. A method of storing a bitstream associated with a video sequence, the method comprising:
generating a bitstream comprising:
an index signaling applying one among a plurality of interpolation filter having higher tap-length than a bilinear filter upon a CU coded by one of a template matching (“TM”)-based mode and decoder-side motion vector refinement (“DMVR”) search; and
storing the bitstream in a non-transitory computer-readable storage medium.
